(19) United States
(12) Patent Application Publication
(10) Pub. No.: US 2025/0346701 A1
(43) Pub. Date: Nov. 13, 2025

(54) RESIN COMPOSITION AND ARTICLE MADE THEREFROM

(71) Applicant: ELITE MATERIAL CO., LTD., Taoyuan City (TW)

(72) Inventor: Chen-Yu HSIEH, Taoyuan City (TW)

(73) Assignee: ELITE MATERIAL CO., LTD., Taoyuan City (TW)

(21) Appl. No.: 18/755,556

(22) Filed: Jun. 26, 2024

(30) Foreign Application Priority Data
May 8, 2024 (TW) 113116963

(51) Int. Cl. C08F 283/08; C08J 5/24

(52) U.S. Cl. CPC C08F 283/085; C08J 5/244; C08J 2451/08

(57) ABSTRACT

A resin composition is provided, comprising a vinyl group-containing resin and a prepolymer. The prepolymer is made from a mixture by a prepolymerization reaction, and the mixture comprises a compound represented by Formula (1) and a compound represented by Formula (2). Also, an article made from the resin composition is provided, comprising a prepreg, a resin film, a laminate or printed circuit board.

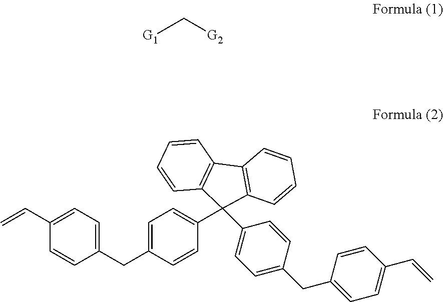

### CROSS-REFERENCE TO RELATED APPLICATIONS

This non-provisional application claims priority under 35 U.S.C. § 119 (a) on patent application No. 113116963 filed in Taiwan (R.O.C.) on May 8, 2024, the entire contents of which are hereby incorporated by reference.

### BACKGROUND

### 1. Technical Field

This present disclosure relates to a resin composition and an article made therefrom.

### 2. Related Art

Recently, with the rapid development of the information industry, electronic products have become increasingly small, lightweight, high-performance and multifunctional. Printed circuit boards serve as basic components of various electronic products and play an important role in supporting and conducting electronic elements thereon. Therefore, in order to meet the constantly upgrading demands of various electronic products, resin compositions for manufacturing printed circuit boards have become a hot research topic.

Currently, printed circuit boards or related articles made from resin compositions still have room for improvement in dissipation factor, copper foil peeling strength, flame retardancy and X-axis coefficient of thermal expansion. Therefore, how to improve the above properties of resin compositions is a development direction in this field.

### SUMMARY

In view of the above problems in the prior arts, specifically, the current material is unable to meet the technical demands, the main purpose of the present disclosure is to provide a resin composition and an article made from the resin composition to solve at least one of the above problems.

One exemplary embodiment of the present disclosure provides a resin composition, comprising a vinyl group-containing resin and a prepolymer, wherein the prepolymer is made from a mixture by a prepolymerization reaction, and the mixture comprises a compound represented by Formula (1) and a compound represented by Formula (2) with a molar ratio between 4:1 and 50:1,

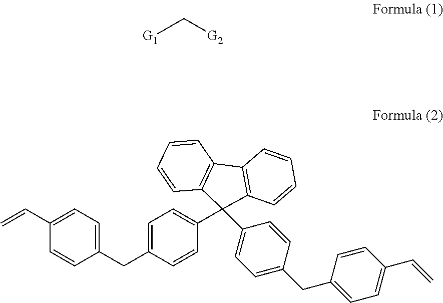

wherein G₁ is or, and
G₂ is

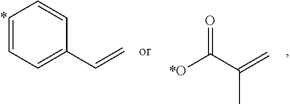

and
wherein a symbol “*” represents a binding site, each of x and y is independently an integer of 0 to 3, and each of R₁ and R₂ is independently C₁-C₃ alkyl group.

Another exemplary embodiment of the present disclosure provides an article made from the resin composition, comprising a prepreg, a resin film, a laminate or a printed circuit board.

The article, such as a prepreg, a resin film, a laminate or a printed circuit board, made from the resin composition of the present disclosure has an excellent performance in at least one of the dissipation factor, the copper foil peeling strength, the flame retardancy and the X-axis coefficient of thermal expansion, therefore, the article can be served as a high-performance substrate that satisfies the comprehensive demands.

### DETAILED DESCRIPTION

The exemplary embodiments disclosed herein are not intended to limit the scope of the present disclosure.

All technical and scientific terms used herein have the common meaning as understood by those skilled in the art. If otherwise specified, the terms defined herein shall prevail.

The terms “comprise,” “include,” “contain,” “have,” or the like belongs to open-ended transitional phrase (i.e., other elements not listed herein may be contained). The terms “consisting of,” “composed by,” “remainder being,” or the like belongs to close-ended transitional phrases.

The phrase “a composition comprises A, B, and C, wherein A comprises a1, a2, or a3” has the same meaning as the phrase “a composition comprises A, B, and C, wherein A comprises a1, a2, a3, or a combination thereof,” that is, “a composition comprises A, B, and C, wherein A comprises a1, a2, a3, a combination of a1 and a2, a combination of a1 and a3, a combination of a2 and a3, or a combination of a1, a2, and a3.”

For the convenience of the description, numerical ranges used herein shall be understood as including all of the possible subranges and individual numerals or values therein, including integers and fractions.

The value used herein includes all of the values which will be the same as such value after being rounded off.

A polymer refers to the product formed by monomer(s) via polymerization and includes multiple aggregates of polymers respectively formed by multiple repeated simple structure units by covalent bonds. The monomer refers to a compound forming the polymer. A polymer may include a homopolymer, a copolymer, a prepolymer, etc., but not limited thereto. The term “polymer” includes an oligomer, but the present disclosure is not limited thereto. An oligomer refers to a polymer with 2 to 20, typically 2 to 5, repeating units. For instance, the term “diene polymer” includes diene homopolymer, diene copolymer, diene prepolymer, and, of course, diene oligomer.

A copolymer refers to a product formed by two or more different monomers via polymerization, including random copolymers, alternating copolymers, graft copolymers, or block copolymers, but the present disclosure is not limited thereto. For instance, a styrene-butadiene copolymer is a product formed by only styrene and butadiene monomers via polymerization. For instance, the styrene-butadiene copolymer includes a styrene-butadiene random copolymer, a styrene-butadiene alternating copolymer, a styrene-butadiene graft copolymer, or a styrene-butadiene block copolymer, but the present disclosure is not limited thereto. The styrene-butadiene block copolymer includes, such as a polymerized molecular structure of styrene-styrene-styrene-butadiene-butadiene-butadiene-butadiene, but the present disclosure is not limited thereto. The styrene-butadiene block copolymer includes, such as a styrene-butadiene-styrene block copolymer, but the present disclosure is not limited thereto. The styrene-butadiene-styrene block copolymer includes, such as a polymerized molecular structure of styrene-styrene-styrene-butadiene-butadiene-butadiene-butadiene-styrene-styrene-styrene, but the present disclosure is not limited thereto. Similarly, a hydrogenated styrene-butadiene copolymer includes a hydrogenated styrene-butadiene random copolymer, a hydrogenated styrene-butadiene alternating copolymer, a hydrogenated styrene-butadiene graft copolymer, or a hydrogenated styrene-butadiene block copolymer. The hydrogenated styrene-butadiene block copolymer includes, such as a hydrogenated styrene-butadiene-styrene block copolymer, but the present disclosure is not limited thereto.

A prepolymer refers to a product, derived from a compound or a mixture (monomer) that is subjected to prepolymerization (partial polymerization), contains unreacted reactive functional groups or has the potential to undergo further polymerization. For instance, the progress of the prepolymerization reaction may be confirmed and controlled as needed by determining the molecular weight or the level of viscosity. Prepolymerization reaction disclosed herein may be initiated by the use of solvent and heating or by a thermal melting reaction, but not limited thereto. For instance, prepolymerization by the use of solvent and heating refers to dissolving the raw material in a solvent, optionally adding a catalyst or a polymerization inhibitor, followed by heating after all components are melted in the solvent, so as to initiate the prepolymerization reaction. For instance, the solvent suitable for the prepolymerization reaction includes butanone, methanol, ethanol, ethylene glycol monomethyl ether, acetone, methyl isobutyl ketone, cyclohexanone, toluene, xylene, methoxyethyl acetate, ethoxyethyl acetate, propoxyethyl acetate, ethyl acetate, propylene glycol monomethyl ether, dimethylformamide, dimethyl acetamide, N-methylpyrrolidon, or a combination thereof. Prepolymerization by a thermal melting reaction refers to heating to melt the raw material and at the same time initiating the prepolymerization reaction. The product after prepolymerization (i.e., the prepolymer) has a molecular weight of greater than that of the compound monomer or mixture monomer prior to prepolymerization and may be analyzed by a gel permeation chromatograph (GPC). In the graph of retention time (X-axis) and molecular weight (Y-axis), the distribution peak of molecular weight of the prepolymer is located closer to the Y-axis (shorter retention time), and the distribution peak of molecular weight of the monomer is located behind (longer retention time). In addition, the obtained prepolymer has a wider distribution of molecular weight that contains multiple adjacent peaks, while the monomer has a narrower distribution of molecular weight that contains only one peak.

It should be understood that a prepolymer formed from compounds A and B and a resin composition including compounds A and B are different substances and have different properties. For instance, the following resin composition 1 and resin composition 2 have different preparation methods and properties, and the physical and chemical properties of the resin composition 1 and resin composition 2 are also different. The resin composition 1 includes a prepolymer and an additive, wherein the prepolymer is formed by compounds A and B. The resin composition 2 includes a prepolymer and an additive. The resin composition 2 includes compounds A and B and additives. The resin composition 1 is formed by forming a prepolymer from the compounds A and B, and the compounds A and B in the prepolymer are partially reacted (partially polymerized), and the resin composition 1 formed by mixing this prepolymer with an additive contains both the prepolymer and the additive. Conversely, the resin composition 2 is a mixture of three substances, namely, compound A, compound B, and an additive. For instance, the resin composition 1 comprises a prepolymer and a cross-linking agent, wherein the prepolymer is formed from the compounds A and B. The product of the resin composition 1 is the product obtained by cross-linking the prepolymer with the cross-linking agent. Conversely, the resin composition 2 comprises compounds A and B and a cross-linking agent, and the product of the resin composition 2 is the product obtained by cross-linking the compounds A and B with the cross-linking agent. The properties of the product of the resin composition 1 and the product of the resin composition 2 are completely different.

For instance, a prepolymer refers to a chemical substance formed by two or more compounds via polymerization with a conversion rate between 10% and 90%.

The term “resin” includes monomer and its combination, polymer and its combination, or a combination of monomer and its polymer, but not limited thereto. For instance, “maleimide resin” used herein includes a maleimide monomer, a maleimide polymer, a combination of maleimide monomers, a combination of maleimide polymers, or a combination of maleimide monomer(s) and maleimide polymer(s).

The term “vinyl group-containing” includes a vinyl group, a vinylbenzyl group, a vinylene group, an allyl group, or (meth)acrylate group.

When a specific example of a compound is expressed as “(substituent)”, it includes both situations of containing and not containing this substituent. For instance, cyclohexane dimethanol di(meth)acrylate includes cyclohexane dimethanol diacrylate and cyclohexane dimethanol dimethacrylate, and (meth)acrylate includes acrylate and methacrylate.

An alkyl group used herein includes various isomers thereof. For instance, a propyl group includes n-propyl group and isopropyl group.

Part(s) by weight represents weight part(s) in any weight unit, such as kilogram, gram, pound and so on, but the present disclosure is not limited thereto. For instance, 100 parts by weight of the vinyl group-containing resin may represent 100 kilograms of the vinyl group-containing resin or 100 pounds of the vinyl group-containing resin. In the case that the resin solution includes solvent and resin, the part(s) by weight of the (solid or liquid) resin generally refers to the weight unit of the (solid or liquid) resin and does not include the weight unit of the solvent in the solution, while the part(s) by weight of the solvent refers to the weight unit of the solvent.

The present disclosure provides a resin composition, including a vinyl group-containing resin and a prepolymer. The prepolymer is made from a mixture by a prepolymerization reaction. The mixture includes a compound represented by Formula (1) and a compound represented by Formula (2) with a molar ratio between 4:1 and 50:1.

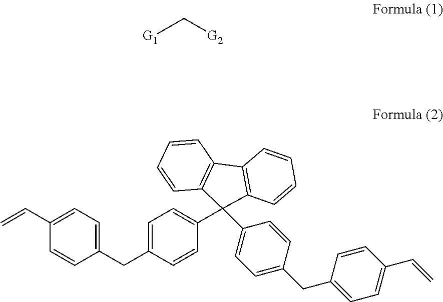

In Formula (1), G₁ is or and
G₂ is

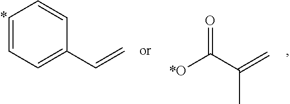

wherein a symbol “*” represents a binding site, each of x and y is independently an integer of 0 to 3, and each of R₁ and R₂ is independently C₁-C₃ alkyl group.

In one exemplary embodiment, in the prepolymerization reaction, the mixture may be made at a temperature of 70° C. to 150° C. by the prepolymerization reaction for 1 hour to 20 hours, and a conversion rate of the compound represented by Formula (1) and the compound represented by Formula (2) may be between 10% and 90%.

In one exemplary embodiment, the resin composition may include 100 parts by weight of the vinyl group-containing resin and 35 to 50 parts by weight of the prepolymer. For instance, the resin composition of the present disclosure may include 100 kilograms of the vinyl group-containing resin and 35 kilograms to 50 kilograms of the prepolymer.

In one exemplary embodiment, the vinyl group-containing resin may include a vinyl group-containing polyphenylene ether resin, a maleimide resin, a diene-containing fluorene compound, a compound represented by Formula (3), a vinylbenzocyclobutene, a styrene-butadiene copolymer, a polybutadiene, a polybutadiene-styrene copolymer grafted with maleic anhydride or a combination thereof, but not limited thereto.

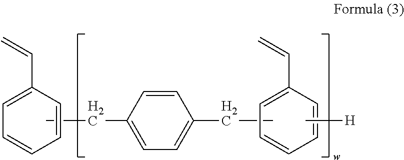

In Formula (3), w may be an integer of 1 to 20.

In one exemplary embodiment, the vinyl group-containing polyphenylene ether resin may include various polyphenylene ether resins whose terminal is modified with a vinyl group or an allyl group. In addition, the vinyl group-containing polyphenylene ether resin may also be polyphenylene ether resins whose terminal is modified with a (meth)acrylate group.

In one exemplary embodiment, the vinyl group-containing polyphenylene ether resin refers to polyphenylene ether resins containing a vinyl group, and the examples thereof may include polyphenylene ether resins containing a vinyl group, an allyl group, a vinylbenzyl group or a (meth)acrylate group, but the present disclosure is not limited thereto. For instance, the vinyl group-containing polyphenylene ether resin may include a vinylbenzyl group-containing biphenyl polyphenylene ether resin, a (meth)acrylate polyphenylene ether resin (i.e. (meth)acryloyl group-containing polyphenylene ether resin), an allyl group-containing polyphenylene ether resin, a vinylbenzyl group-modified bisphenol A polyphenylene ether resin, a vinyl group-containing chain-extended polyphenylene ether resin or a combination thereof. For instance, the vinyl group-containing polyphenylene ether resin may be a vinylbenzyl group-containing biphenyl polyphenylene ether resin with a number average molecular weight of about 1200 (such as OPE-2st 1200, available from Mitsubishi Gas Chemical Co., Inc.), a vinylbenzyl group-containing biphenyl polyphenylene ether resin with a number average molecular weight of about 2200 (such as OPE-2st 2200, available from Mitsubishi Gas Chemical Co., Inc.), a methacrylate polyphenylene ether resin with a number average molecular weight of about 1900 to 2300 (such as SA9000, available from Sabic company), a vinylbenzyl group-modified bisphenol A polyphenylene ether resin with a number average molecular weight of about 2400 to 2800, a vinyl group-containing chain-extended polyphenylene ether resin with a number average molecular weight of about 2200 to 3000 or a combination thereof. Among them, the vinyl group-containing chain-extended polyphenylene ether resin may include various polyphenylene ether resins disclosed in the US Patent Application Publication No. 2016/0185904 A1, all of which are incorporated herein by reference in their entirety.

In one exemplary embodiment, the maleimide resin may include monomers having one or more maleimide groups in the molecule or a combination thereof. The maleimide resin applied in the present disclosure is not particularly limited, and may be one or more maleimide resins suitable for manufacturing prepregs, resin films, laminates or printed circuit boards. For instance, the maleimide resin may include 4,4′-diphenylmethane bismaleimide, oligomer of phenylmethane maleimide (or polyphenylmethane maleimide), bisphenol A diphenyl ether bismaleimide, 3,3′-dimethyl-5,5′-diethyl-4,4′-diphenylmethane bismaleimide (or bis(3-ethyl-5-methyl-4-maleimidephenyl)methane), 3,3′-dimethyl-5,5′-dipropyl-4,4′-diphenylmethane bismaleimide, biphenyl maleimide, m-phenylene bismaleimide, 4-methyl-1,3-phenylene bismaleimide, 1,6-bismaleimide-(2,2,4-trimethyl) hexane, N-2,3-xylylmaleimide, N-2,6-xylylmaleimide, N-phenylmaleimide, diethyl bismaleimidotoluene, vinyl benzyl maleimide (VBM), aliphatic long chain structure-containing maleimide resin or a combination thereof. The maleimide resin includes modifications thereof.

For instance, the maleimide resin may be maleimide resin product BMI-1000, BMI-1000H, BMI-1100, BMI-1100H, BMI-2000, BMI-2300, BMI-3000, BMI-3000H, BMI-4000, BMI-5000, BMI-5100, BMI-TMH, BMI-7000 or BMI-7000H available from Daiwakasei Industry Co., Ltd.; maleimide resin product BMI-70 or BMI-80 available from K.I Chemical Co., Ltd.; maleimide resin product MIR-3000 or MIR-5000 available from Nippon Kayaku; or maleimide resin product DE-TDAB available from Evonik Industries.

For instance, the aliphatic long chain structure-containing maleimide resin may be maleimide resin product BMI-689, BMI-1400, BMI-1500, BMI-1700, BMI-2500, BMI-3000, BMI-5000 or BMI-6000 available from Designer Molecules Inc.

In one exemplary embodiment, the resin composition may further include an inorganic filler, a flame retardant, a curing accelerator, a polymerization inhibitor, a solvent, a silane coupling agent, a coloring agent, a toughening agent or a combination thereof. In one exemplary embodiment, the resin composition may further include a hydrogenated styrene-butadiene-styrene block copolymer. The amount of the above components is not limited and may be used alone or combined.

In one exemplary embodiment, the inorganic filler may be silica. In one exemplary embodiment, the amount of the inorganic filler may be 60 parts by weight to 120 parts by weight, with respect to 100 parts by weight of the vinyl group-containing resin. In one exemplary embodiment, the inorganic filler may be spherical silica. In one exemplary embodiment, the spherical silica may include various spherical silica known in this field. For instance, the particle size distribution D50 of the spherical silica may be less than or equal to 2.0 μm. For instance, the particle size distribution D50 may be preferably between 0.2 μm and 2.0 μm. The particle size distribution D50 refers to a particle size of the filler, such as spherical silica, measured by laser scattering when the cumulative volume percentage reaches 50%, but the present disclosure is not limited thereto. The spherical silica may be any one or more of commercial products.

In one exemplary embodiment, the inorganic filler may be inorganic fillers other than the spherical silica, and the amount thereof may be adjusted as needed. In one exemplary embodiment, the inorganic filler other than the spherical silica may include non-spherical silica (i.e. irregular silica known in the field, wherein irregular means not spherical), aluminum oxide, aluminum hydroxide, magnesium oxide, magnesium hydroxide, calcium carbonate, aluminum nitride, boron nitride, aluminum silicon carbide, silicon carbide, titanium dioxide, barium titanate, lead titanate, strontium titanate, calcium titanate, magnesium titanate, barium zirconate, lead zirconate, magnesium zirconate, lead zirconate titanate, zinc molybdate, calcium molybdate, magnesium molybdate, ammonium molybdate, zinc molybdate-modified talc, zinc oxide, zirconium oxide, mica, boehmite (AlOOH), calcined talc, talc, silicon nitride or calcined kaolin. In addition, except for the non-spherical silica, other inorganic fillers may be spherical, fibrous, plate, particulate, flake or whisker, but the present disclosure is not limited thereto.

In one exemplary embodiment, the silane coupling agent may include silane, such as siloxane, and based on the functional group, the silane may be divided into amino silane, epoxide silane, vinyl silane, ester silane, hydroxyl silane, isocyanate silane, methacryloyloxyl silane and acryloyloxyl silane, but the present disclosure is not limited thereto.

In one exemplary embodiment, the polymerization inhibitor may include various molecule type polymerization inhibitors or stable free radical type polymerization inhibitors known in this field. The molecule type polymerization inhibitor may include phenols, quinones, arylamines, arene nitro compounds, sulfur-containing compounds or chlorides of metal with variable valency, but the present disclosure is not limited thereto. For instance, the molecule type polymerization inhibitor may include phenol, hydroquinone, 4-tert-butylcatechol, benzoquinone, chloroquinone, 1,4-naphthoquinone, trimethylquinone, aniline, nitrobenzene, Na₂S, FeCl₃ or CuCl₂, but the present disclosure is not limited thereto. For instance, the stable free radical type polymerization inhibitor may include 1,1-diphenyl-2-picrylhydrazyl radical (DPPH), triphenylmethyl radical, 2,2,6,6-tetramethylpiperidine-1-oxide or derivatives of 2,2,6,6-tetramethylpiperidine-1-oxide, but the present disclosure is not limited thereto.

In one exemplary embodiment, the flame retardant may include a phosphorus-containing flame retardant, but the present disclosure is not limited thereto. For instance, the phosphorus-containing flame retardant may include ammonium polyphosphate, hydroquinone bis(diphenyl phosphate), bisphenol A bis(diphenylphosphate), tri (2-carboxyethyl) phosphine (TCEP), tris(chloroisopropyl) phosphate, trimethyl phosphate (TMP), dimethyl methyl phosphonate (DMMP), resorcinol bis(dixylenyl phosphate), resorcinol bis(di-2,6-dimethylphenyl phosphate) (such as commercial product PX-200), hydroquinone bis(di-2,6-dimethylphenyl phosphate) (such as commercial product PX-201), 4,4′-biphenol bis(di-2,6-dimethylphenyl phosphate) (such as commercial product PX-202), phosphazene (such as commercial product SPB-100, SPH-100 or SPV-100), melamine polyphosphate, 9,10-dihydro-9-oxa-10-phosphaphenanthrene-10-oxide (DOPO) and its derivatives (such as di-DOPO compounds) or resins (such as DOPO-HQ, DOPO-NQ, DOPO-PN or DOPO-BPN), DOPO-bonding epoxy resin, diphenylphosphine oxide (DPPO) and its derivatives (such as di-DPPO compounds) or resins, melamine cyanurate, tri-hydroxyethyl isocyanurate or aluminium phosphinate (such as commercial product OP-930 or OP-935). Among them, DOPO-PN is DOPO-containing phenol novolac resin, and DOPO-BPN may be bisphenol novolac resin such as DOPO-BPAN (DOPO-bisphenol A novolac), DOPO-BPFN (DOPO-bisphenol F novolac) or DOPO-BPSN (DOPO-bisphenol S novolac), but not limited thereto.

In one exemplary embodiment, the curing accelerator may include, but limited to, an initiator. For instance, the initiator may include bis(tert-butylperoxyisopropyl)benzene, 2,5-dimethyl-2,5-di(tert-butylperoxy)-3-hexyne, dibenzoyl peroxide, 2,3-dimethyl-2,3-diphenylbutane, dicumyl peroxide, tert-butyl peroxybenzoate, tert-butyl peroxyisopropyl monocarbonate, azobisisobutylonitrile or 2,2′-azobis(2,4,4-trimethylpentane), but not limited thereto. In one exemplary embodiment, the amount of the initiator may be 0.35 parts by weight to 0.85 parts by weight, with respect to 100 parts by weight of the vinyl group-containing resin.

In one exemplary embodiment, the coloring agent may include dye or pigment, but not limited thereto.

In one exemplary embodiment, the main purpose of adding the toughening agent is to improve the toughness of the resin composition, and the toughening agent may include rubbers such as carboxyl-terminated butadiene acrylonitrile rubber (CTBN), but not limited thereto.

In one exemplary embodiment, the main purpose of adding the solvent is to dissolve the components in the resin composition, to modify the solid content of the resin composition, and to adjust the viscosity of the resin composition. For instance, the solvent may include methanol, ethanol, ethylene glycol monomethyl ether, acetone, butanone (i.e., methyl ethyl ketone), methyl isobutyl ketone, cyclohexanone, toluene, xylene, methoxyethyl acetate, ethoxyethyl acetate, propoxyethyl acetate, ethyl acetate, propylene glycol methyl ether, dimethyl formamide, dimethyl acetamide, N-methylpyrrolidone or a mixed solvent thereof, but not limited thereto. The amount of the solvent is not particularly limited and may be adjusted depending on the desired viscosity of the resin composition. In the case of adding the solvent to the resin composition, the solvent is evaporated and removed during heating the resin composition at high temperature to form a semi-cured state, and thus no solvent or only a trace amount of the solvent is present in the article. Therefore, the presence or absence of the solvent in the resin composition does not affect the properties of the article.

The resin composition of one exemplary embodiment of the present disclosure may be made into various articles including a prepreg, a resin film, a laminate or a printed circuit board by various processing ways, but not limited thereto.

In one exemplary embodiment, the resin composition of the present disclosure may be made into a prepreg, which includes a reinforcement material and a layered structure disposed thereon. The layered structure is formed by heating the resin composition at a high temperature to a semi-cured state (B-stage). The baking temperature for making the prepreg may be between 100° C. and 150° C. The reinforcement material may be any one of fiber material, woven fabric and non-woven fabric. The woven fabric may include fiberglass fabrics. The fiberglass fabrics may be various fiberglass fabric used for printed circuit boards, such as E-glass fabric, D-glass fabric, S-glass fabric, T-glass fabric, L-glass fabric or Q-glass fabric; and the type of the fiberglass may include yarns and rovings, in spread form or standard form. The non-woven fabric may include liquid crystal resin non-woven fabric, such as polyester non-woven fabric, polyurethane non-woven fabric and so on, but not limited thereto. The woven fabric may also include liquid crystal resin woven fabric, such as polyester woven fabric, polyurethane woven fabric and so on, but not limited thereto. The reinforcement material may increase the mechanical strength of the prepreg.

In one exemplary embodiment, the resin composition of the present disclosure may be made into a resin film, which is prepared by heating and baking to semi-cure the resin composition. The resin composition may be selectively coated on a polyethylene terephthalate film (PET film), a polyimide film (PI film), a copper foil or a resin-coated copper, followed by heating and baking to a semi-cured state so as to make the resin composition into the resin film.

In one exemplary embodiment, the resin composition of the present disclosure may be made into a laminate, which includes at least two metal foils and at least one insulation layer disposed between the two metal foils. The insulation layer may be made by curing the resin composition at high temperature and high pressure to C-stage, wherein a suitable curing temperature may be between 180° C. and 250° C., preferably between 200° C. and 220° C., and a curing time may be 80 to 150 minutes, preferably 90 to 120 minutes. The insulation layer may be formed by curing the prepreg or the resin film to C-stage. The material of the metal foil may be copper, aluminum, nickel, platinum, silver, gold or alloy thereof, for instance, the metal foil may be a copper foil. In one exemplary embodiment, the laminate is a copper-clad laminate (CCL).

In one exemplary embodiment, the laminate may be further processed by circuit formation processes to be made into a circuit board, such as a printed circuit board.

In one exemplary embodiment, the article made from the resin composition of the present disclosure may have one or more of the following properties:
a dissipation factor at 10 Hz as measured by reference to JIS C2565 of less than 0.0030, such as between 0.0020 and 0.0027;
a copper foil peeling strength as measured by reference to IPC-TM-650 2.4.8 of greater than 4.20 lb/in, such as between 4.29 lb/in and 5.31 lb/in;
a flame retardancy as measured by reference to UL94 rating of V-0; and
an X-axis coefficient of thermal expansion as measured by reference to IPC-TM-650 2.4.24.5 of less than 14.0 ppm/° C., such as between 11.7 ppm/° C. and 13.1 ppm/° C.

The chemical materials used in Synthesis Examples of the prepolymer, Examples of the resin composition and Comparative Examples of the resin composition are described as follows: Prepolymers P1 to P8: prepared by Synthesis Example 1 to Synthesis Example 8.

Methacrylate-containing polyphenylene ether resin: prepared by Synthesis Example 9.

OPE-2st 2200: vinylbenzyl group-containing biphenyl polyphenylene ether resin, available from Mitsubishi Gas Chemical Co.

SA9000: methacrylate-containing polyphenylene ether resin, available from Sabic company.

BMI-3000: aliphatic long chain structure-containing maleimide resin, available from Designer Molecules Inc.

CHR-2ST: diene-containing fluorene compound, available from Shandong Xingshun New Material Co., Ltd.

Compound of Formula (3): the compound represented by Formula (3), prepared by Synthesis Example 10.

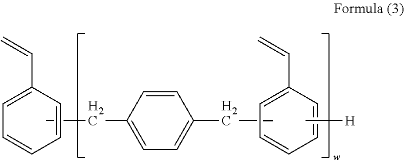

w is an integer of 1 to 20.

4-vinylbenzocyclobutene: commercially available.

Ricon 100: styrene-butadiene copolymer, available from Cray Valley.

B-1000: polybutadiene, available from Nippon Soda.

Ricon184MA6: polybutadiene-styrene copolymer grafted with maleic anhydride, available from Cray Valley.

H1051: hydrogenated styrene-butadiene-styrene block copolymer (SEBS), available from Asahi KASEI.

SC2050: silica, available from Admatechs.

2,2′-azobis(2,4,4-trimethylpentane): commercially available.

MEK: butanone, commercially available.

Compound of Formula (2): the compound represented by Formula (2), commercially available.

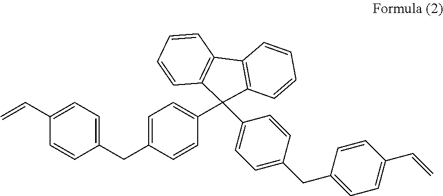 [SMILES: C=Cc1ccc(Cc2ccc(C3(c4ccc(Cc5ccc(C=C)cc5)cc4)c4ccccc4-c4ccccc43)cc2)cc1]

### Synthesis Example 1

Compound of Formula (1.1) (available from Shandong Xingshun New Material Co., Ltd.), Compound of Formula (2) (available from Shandong Xingshun New Material Co., Ltd.), 0.5 wt % of the former two of 2,2′-azobis(2,4,4-trimethylpentane) and the solvent (such as MEK) are added to a three-necked flask and stirred to form a mixture solution. The solid content of the mixture solution is about 60 wt %. The molar ratio of Compound of Formula (1.1) to Compound of Formula (2) is 15:1. The mixture solution is heated from room temperature to 80° C. and stirred for 4 hours to obtain Prepolymer P1 of the present disclosure.

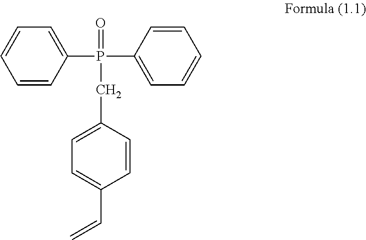 [SMILES: C=Cc1ccc(CP(=O)(c2ccccc2)c2ccccc2)cc1]

### Synthesis Example 2

Compound of Formula (1.2) (available from Shandong Xingshun New Material Co., Ltd.), Compound of Formula (2), 0.5 wt % of the former two of 2,2′-azobis(2,4,4-trimethylpentane) and the solvent (such as MEK) are added to a three-necked flask and stirred to form a mixture solution. The solid content of the mixture solution is about 60 wt %. The molar ratio of Compound of Formula (1.2) to Compound of Formula (2) is 50:1. The mixture solution is heated from room temperature to 80° C. and stirred for 4 hours to obtain Prepolymer P2 of the present disclosure.

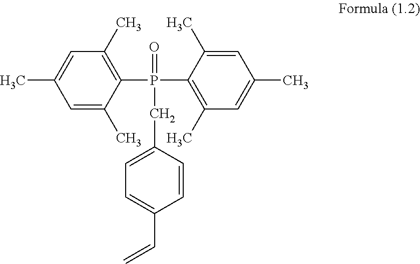

### Synthesis Example 3

Compound of Formula (1.3) (available from Shandong Xingshun New Material Co., Ltd.), Compound of Formula (2), 0.5 wt % of the former two of 2,2′-azobis(2,4,4-trimethylpentane) and the solvent (such as MEK) are added to a three-necked flask and stirred to form a mixture solution. The solid content of the mixture solution is about 60 wt %. The molar ratio of Compound of Formula (1.3) to Compound of Formula (2) is 15:1. The mixture solution is heated from room temperature to 80° C. and stirred for 4 hours to obtain Prepolymer P3 of the present disclosure. 10

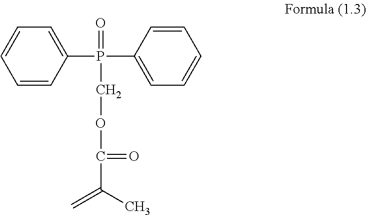 [SMILES: C=C(C)C(=O)OCP(=O)(c1ccccc1)c1ccccc1]

### Synthesis Example 4

Compound of Formula (1.4) (available from Shandong Xingshun New Material Co., Ltd.), Compound of Formula (2), 0.5 wt % of the former two of 2,2′-azobis(2,4,4-trimethylpentane) and the solvent (such as MEK) are added to a three-necked flask and stirred to form a mixture solution. The solid content of the mixture solution is about 60 wt %. The molar ratio of Compound of Formula (1.4) to Compound of Formula (2) is 30:1. The mixture solution is heated from room temperature to 80° C. and stirred for 4 hours to obtain Prepolymer P4 of the present disclosure.

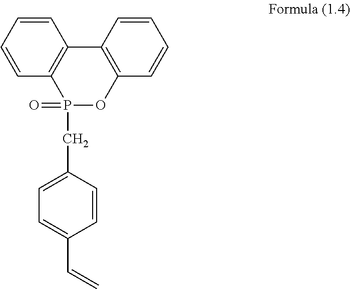 [SMILES: C=Cc1ccc(CP2(=O)Oc3ccccc3-c3ccccc32)cc1]

### Synthesis Example 5

Compound of Formula (1.5) (available from Shandong Xingshun New Material Co., Ltd.), Compound of Formula (2), 0.5 wt % of the former two of 2,2′-azobis(2,4,4-trimethylpentane) and the solvent (such as MEK) are added to a three-necked flask and stirred to form a mixture solution. The solid content of the mixture solution is about 60 wt %. The molar ratio of Compound of Formula (1.5) to Compound of Formula (2) is 4:1. The mixture solution is heated from room temperature to 80° C. and stirred for 4 hours to obtain Prepolymer P5 of the present disclosure.

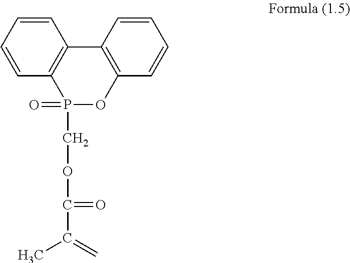 [SMILES: C=C(C)C(=O)OCP1(=O)Oc2ccccc2-c2ccccc21]

### Synthesis Example 6

4.5 g Compound of Formula (1.1), 0.0225 g azobisisobutyronitrile (AIBN) and the solvent (such as DMAc) are added to a three-necked flask and stirred to form a mixture solution. The solid content of the mixture solution is about 30 wt %. The mixture solution is heated from room temperature to 120° C., stirred for 16 hours, and purified to obtain Prepolymer P6.

### Synthesis Example 7

4.5 g Compound of Formula (2), 0.0225 g azobisisobutyronitrile (AIBN) and the solvent (such as DMAc) are added to a three-necked flask and stirred to form a mixture solution. The solid content of the mixture solution is about 30 wt %. The mixture solution is heated from room temperature to 120° C., stirred for 16 hours, and purified to obtain Prepolymer P7.

### Synthesis Example 8

Compound of Formula (1.1), Compound of Formula (4) (prepared by Synthesis Example 11), 0.5 wt % of the former two of 2,2′-azobis(2,4,4-trimethylpentane) and the solvent (such as MEK) are added to a three-necked flask and stirred to form a mixture solution. The solid content of the mixture solution is about 60 wt %. The molar ratio of Compound of Formula (1.1) to Compound of Formula (4) is 15:1. The mixture solution is heated from room temperature to 80° C. and stirred for 4 hours to obtain Prepolymer P8.

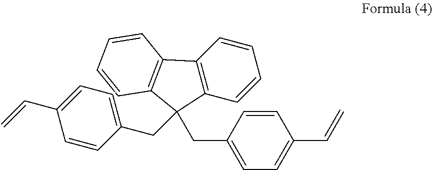 [SMILES: C=Cc1ccc(CC2(Cc3ccc(C=C)cc3)c3ccccc3-c3ccccc32)cc1]

### Synthesis Example 9

400 g (0.2 mol) hydroxyl group-containing polyphenylene ether resin (SA90, available from Sabic company), 17.5 g (0.1 mol) α,α′-dichloro-p-xylene, 33.9 g (0.01 mol) tetrabutylphosphonium bromide and 600 g toluene are added to a stirring tank, heated to 75° C., and stirred and dissolved. Then, they are heated to 95° C., and 45 g (1.125 mol) NaOH and 33 g deionized water are added thereto and stirred for 6 hours. Then, they are cooled down to 70° C., and 36.6 g (0.35 mol) methacryloyl chloride is added thereto, stirred for 4 hours, cooled down to room temperature, and 8.8 g (0.09 mol) phosphoric acid and 165 g deionized water are added thereto for neutralization. Then, the solution is stood to separate into upper and lower layers. 330 g deionized water is added thereto and stirred, and the waste is removed in three times. Finally, the solvent is removed by reduced pressure distillation to obtain the methacrylate-containing polyphenylene ether resin.

### Synthesis Example 10

296 parts by weight of (2-bromoethyl)benzene (available from Tokyo Chemical Industry Co., Ltd.), 70 parts by weight of α,α′-dichloro-p-xylene (available from Tokyo Chemical Industry Co., Ltd.) and 18.4 parts by weight of methanesulfonic acid (available from Tokyo Chemical Industry Co., Ltd.) are reacted at 130° C. for 8 hours, then cooled down to room temperature, neutralized by sodium hydroxide, and then extracted with 1200 parts by weight of toluene. The organic layer is washed with water. The solvent and the excessive (2-bromoethyl)benzene are removed by distillation under heating and reduced pressure to obtain an intermediate. The molar ratio of (2-bromoethyl)benzene to α,α′-dichloro-p-xylene may be 4:1, methanesulfonic acid serves as an acidic catalyst and may be replaced by other acidic catalysts such as hydrochloric acid or phosphoric acid, and the reaction condition may be at 40° C. to 180° C. for 0.5 hours to 20 hours.

22 parts by weight of the intermediate, 50 parts by weight of toluene (other aromatic solvents such as xylene may also be used), 150 parts by weight of dimethyl sulfoxide (other aprotic polar solvents such as dimethyl sulfone may also be used), 15 parts by weight of water and 5.4 parts by weight of sodium hydroxide (other basic catalysts such as potassium hydroxide and potassium carbonate may also be used) are reacted at 40° C. for 5 hours, then cooled down to room temperature, and 100 parts by weight of toluene is added thereto. The organic layer is washed with water. The solvent is removed by distillation under heating and reduced pressure to obtain Compound of Formula (3).

### Synthesis Example 11

249 g (1.5 mol) fluorine, 250 g toluene and 22 g (0.069 mol) tetra-n-butylammonium bromide are put into a flask equipped with a temperature controller, a stirrer, a condenser, a dropping funnel and an oxygen inlet. 458 g (3.0 mol) vinylbenzyl chloride is added to the flask, stirred and heated to 40° C., and 240 g of 50 wt % NaOH solution is added thereto, heated to 60° C., and reacted for 8 hours, then neutralized with hydrochloric acid, washed with distilled water twice, and distilled under reduced pressure to obtain Compound of Formula (4).

The resin compositions of Examples and Comparative Examples of the present disclosure are prepared according to the amount of the chemical materials listed in Tables 1 to 4 and further made into various samples (test samples). The samples are prepared according to the following methods, and the property tests thereof are performed based on the specific test conditions.

### 1. Prepreg 1 (PP 1)

The resin compositions from each Examples and each Comparative Examples are used, and the components thereof are separately added to a stirring tank and well-mixed to form a varnish. The varnish is loaded into an impregnation tank, and a fiberglass fabric (e.g., 1078 L-glass fiber fabric, available from Asahi) is immersed into the impregnation tank to adhere the resin composition onto the fiberglass fabric, followed by heating at 100° C. to 140° C. to a semi-cured state (B stage), thereby obtaining Prepreg 1 with a resin content of 70%.

### 2. Prepreg 2 (PP 2)

The resin compositions from each Examples and each Comparative Examples are used, and the components thereof are separately added to a stirring tank and well-mixed to form a varnish. The varnish is loaded into an impregnation tank, and a fiberglass fabric (e.g., 2116 L-glass fiber fabric, available from Asahi) is immersed into the impregnation tank to adhere the resin composition onto the fiberglass fabric, followed by heating at 100° C. to 140° C. to a semi-cured state (B stage), thereby obtaining Prepreg 2 with a resin content of 70%.

### 3. Copper-Clad Laminate 1 (Formed by Laminating Two Prepregs 1)

Two hyper very low profile (HVLP) copper foils with a thickness of 1 ounce and two Prepregs 1 obtained from 1078 L-glass fiber fabrics impregnated with each of Examples and Comparative Examples and each having a resin content of about 70% are prepared. They are stacked in an order of one copper foil, two Prepregs 1 and one copper foil, followed by lamination under vacuum at 250 psi to 600 psi and 200° C. to 220° C. for 90 minutes to 120 minutes to form Copper-clad laminate 1. The two Prepregs 1 are cured and formed into an insulation layer between the two copper foils, and the insulation layer has a resin content of about 70%.

### 4. Copper-Clad Laminate 2 (Formed by Laminating Six Prepregs 1)

The preparation method of Copper-clad laminate 2 is basically the same as that of Copper-clad laminate 1, and the difference is that the insulation layer is composed of six Prepregs 1.

### 5. Copper-Clad Laminate 3 (Formed by Laminating Eight Prepregs 1)

The preparation method of Copper-clad laminate 3 is basically the same as that of Copper-clad laminate 1, and the difference is that the insulation layer is composed of eight Prepregs 1.

### 6. Copper-Clad Laminate 4 (Formed by Laminating Two Prepregs 2)

Two hyper very low profile (HVLP) copper foils with a thickness of 1 ounce and two Prepregs 2 obtained from 2116 L-glass fiber fabrics impregnated with each of Examples and Comparative Examples and each having a resin content of about 70% are prepared. They are stacked in an order of one copper foil, two Prepregs 2 and one copper foil, followed by lamination under vacuum at 250 psi to 600 psi and 200° C. to 220° C. for 90 minutes to 120 minutes to form Copper-clad laminate 4. The two Prepregs 2 are cured and formed into an insulation layer between the two copper foils, and the insulation layer has a resin content of about 70%.

### 7. Copper-Free Laminate 1 (Formed by Laminating Two Prepregs 1)

Copper-clad laminate 1 is etched to remove two copper foils, thereby obtaining Copper-free laminate 1 (formed by laminating two Prepregs 1).

### 8. Copper-Free Laminate 2 (Formed by Laminating Eight Prepregs 1)

Copper-clad laminate 3 is etched to remove two copper foils, thereby obtaining Copper-free laminate 2 (formed by laminating eight Prepregs 1).

### 9. Copper-Free Laminate 3 (Formed by Laminating Two Prepregs 2)

Copper-clad laminate 4 is etched to remove two copper foils, thereby obtaining Copper-free laminate 3 (formed by laminating two Prepregs 2).

For above samples, the test method and the property analysis are described below.

### Dissipation Factor (Df)

In the measurement of the dissipation factor, the above Copper-free laminates 1 (formed by laminating two Prepregs 1, with a resin content of about 70%) is used as a sample. Each sample is measured for the dissipation factor at 10 GHz at room temperature (about 25° C.) by reference to JIS C2565 using a microwave dielectrometer (available from AET Corp.). At a measurement frequency of 10 GHz, for Df value less than 0.0050, a difference in Df values of less than 0.0003 represents no significant difference in dissipation factors of different laminates (i.e., no significant technical difficulty is present), while a difference in Df values of greater than or equal to 0.0003 represents a significant difference in dissipation factors of different laminates (i.e., significant technical difficulty is present).

Copper foil peeling strength (1 ounce) (1 oz peeling strength, 1 oz P/S)

One Copper-clad laminate 2 (formed by laminating six Prepregs 1) is prepared and cut into a rectangular sample with a width of 24 mm and a length of 80 mm, and the sample is etched to remove the surface copper foil and leave a strip copper foil with a width of 3.18 mm and a length of greater than 60 mm. The sample is measured for one-ounce copper foil peeling strength (1 oz P/S) in lb/in at room temperature (about 25° C.) by reference to IPC-TM-650 2.4.8 using a tensile strength tester. In this field, the higher copper foil peeling strength is better.

### Flame Retardancy (Flame Resistance)

One Copper-free laminate 2 (formed by laminating eight Prepregs 1) is prepared and used as a sample. The flame retardancy test is performed in accordance with the UL 94 rating, and the results are represented by V-0, V-1, or V-2, wherein V-O indicates a superior flame retardancy to V-1, V-1 indicates a superior flame retardancy to V-2, and burn out indicates the worst case.

### X-Axis Coefficient of Thermal Expansion (X-CTE)

One Copper-free laminate 3 (formed by laminating two Prepregs 2) is prepared and used as a sample for thermal mechanical analysis (TMA). Copper-free laminate 3 is cut into a sample with a length of 24 mm and a width of 3 mm. The sample is heated at a rate of 10° C. per minute from 35° C. to 350° C., and each sample is measured for X-axis coefficient of thermal expansion (in ppm/° C.) in a temperature range (a1) of 40° C. to 125° C. by reference to IPC-TM-650 2.4.24.5. The X-axis coefficient of thermal expansion herein refers to the coefficient of thermal expansion in X-axis direction of the sample. The lower X-axis coefficient of thermal expansion means a better dimensional change property. A difference in X-axis coefficient of thermal expansions of greater than or equal to 1.5 ppm/° C. represents a significant difference in X-axis coefficient of thermal expansions of different laminates (i.e., significant technical difficulty is present).

TABLE 1
The components of the resin compositions (in parts by weight)
and the property test results of Examples E1 to E4

| Component | | E1 | E2 | E3 | E4 |
|---|---|---|---|---|---|
| Prepolymer | P1 | 35 | — | — | — |
| | P2 | — | 35 | — | — |
| | P3 | — | — | 35 | — |
| | P4 | — | — | — | 35 |
| | P5 | — | — | — | — |
| | P6 | — | — | — | — |
| | P7 | — | — | — | — |
| | P8 | — | — | — | — |
| Vinyl | Methacrylate-containing | 65 | 60 | — | — |
| group- | polyphenylene ether resin | | | | |
| containing | OPE-2st 2200 | 5 | 5 | — | — |
| resin | SA9000 | 10 | 5 | 70 | 100 |
| | BMI-3000 | 10 | — | — | — |
| | CHR-2ST | 10 | — | — | — |
| | Compound of Formula (3) | — | 30 | — | — |
| | 4-vinylbenzocyclobutene | — | — | 30 | — |
| | Ricon 100 | — | — | — | — |
| | B-1000 | — | — | — | — |
| | Ricon184MA6 | — | — | — | — |
| Additive | H1051 | — | — | — | — |
| | Compound of Formula | — | — | — | — |
| | (1.1) | | | | |
| | Compound of Formula (2) | — | — | — | — |
| Filler | SC2050 | 80 | 80 | 80 | 80 |
| Initiator | 2,2′-azobis(2,4,4- | 0.35 | 0.35 | 0.35 | 0.35 |
| | trimethylpentane) | | | | |
| Solvent | MEK | 50 | 50 | 50 | 50 |

| Property | Unit | E1 | E2 | E3 | E4 |
|---|---|---|---|---|---|
| Df@10 GHz | — | 0.0022 | 0.0024 | 0.0024 | 0.0024 |
| P/S | lb/in | 4.36 | 4.29 | 4.53 | 4.43 |
| UL-94 | — | V-0 | V-0 | V-0 | V-0 |
| X-CTE | ppm/° C. | 12.3 | 13.1 | 12.7 | 13.1 |

TABLE 2
The components of the resin compositions (in parts by weight)
and the property test results of Examples E5 to E8

| Component | | E5 | E6 | E7 | E8 |
|---|---|---|---|---|---|
| Prepolymer | P1 | 50 | 40 | 4 | 3 |
| | P2 | — | — | 2 | 5 |
| | P3 | — | — | 20 | 10 |
| | P4 | — | — | 15 | 7 |
| | P5 | — | — | 9 | 10 |
| | P6 | — | — | — | — |
| | P7 | — | — | — | — |
| | P8 | — | — | — | — |
| Vinyl | Methacrylate-containing | — | — | — | 20 |
| group- | polyphenylene ether resin | | | | |
| containing | OPE-2st 2200 | 35 | 50 | 27 | 34 |
| resin | SA9000 | 30 | 50 | 40 | 10 |
| | BMI-3000 | — | — | 2 | 4 |
| | CHR-2ST | — | — | 5 | 3 |
| | Compound of Formula (3) | — | — | 10 | 13 |
| | 4-vinylbenzocyclobutene | 20 | — | 3 | 5 |
| | Ricon 100 | 13 | — | 6 | 6 |
| | B-1000 | — | — | 4 | 2 |
| | Ricon184MA6 | 2 | — | 3 | 3 |
| Additive | H1051 | — | — | 2 | 2 |
| | Compound of Formula | — | — | — | — |
| | (1.1) | | | | |
| | Compound of Formula (2) | — | — | — | — |
| Filler | SC2050 | 80 | 80 | 60 | 120 |
| Initiator | 2,2′-azobis(2,4,4- | 0.35 | 0.35 | 0.65 | 0.85 |
| | trimethylpentane) | | | | |
| Solvent | MEK | 50 | 50 | 60 | 100 |

| Property | Unit | E5 | E6 | E7 | E8 |
|---|---|---|---|---|---|
| Df@10 GHz | — | 0.0025 | 0.0027 | 0.0021 | 0.0020 |
| P/S | lb/in | 5.27 | 5.01 | 5.24 | 5.31 |
| UL-94 | — | V-0 | V-0 | V-0 | V-0 |
| X-CTE | ppm/° C. | 12.5 | 12.1 | 11.7 | 11.9 |

TABLE 3
The components of the resin compositions (in parts by weight)
and the property test results of Comparative Examples C1 to C4

| Component | | C1 | C2 | C3 | C4 |
|---|---|---|---|---|---|
| Prepolymer | P1 | — | — | — | — |
| | P2 | — | — | — | — |
| | P3 | — | — | — | — |
| | P4 | — | — | — | — |
| | P5 | — | — | — | — |
| | P6 | 35 | — | — | — |
| | P7 | — | 35 | — | — |
| | P8 | — | — | 35 | — |
| Vinyl | Methacrylate- | — | — | — | — |
| group- | containing | | | | |
| containing | polyphenylene | | | | |
| resin | ether resin | | | | |
| | OPE-2st 2200 | — | — | — | — |
| | SA9000 | 100 | 100 | 100 | 100 |
| | BMI-3000 | — | — | — | — |
| | CHR-2ST | — | — | — | — |
| | Compound of | — | — | — | — |
| | Formula (3) | | | | |
| | 4-vinylbenzocyclo- | — | — | — | — |
| | butene | | | | |
| | Ricon 100 | — | — | — | — |
| | B-1000 | — | — | — | — |
| | Ricon184MA6 | — | — | — | — |
| Additive | H1051 | — | — | — | — |
| | Compound of | — | — | — | 35 |
| | Formula (1.1) | | | | |
| | Compound of | — | — | — | — |
| | Formula (2) | | | | |
| Filler | SC2050 | 80 | 80 | 80 | 80 |
| Initiator | 2,2′-azobis(2,4,4- | 0.35 | 0.35 | 0.35 | 0.35 |
| | trimethylpentane) | | | | |
| Solvent | MEK | 50 | 50 | 50 | 50 |

| Property | Unit | C1 | C2 | C3 | C4 |
|---|---|---|---|---|---|
| Df@10 GHz | — | 0.0036 | 0.0039 | 0.0031 | 0.0039 |
| P/S | lb/in | 3.99 | 3.67 | 4.12 | 3.35 |
| UL-94 | — | V-1 | V-1 | V-0 | Burn out |
| X-CTE | ppm/° C. | 15.2 | 15.4 | 15.1 | 16.2 |

TABLE 4
The components of the resin compositions (in parts by weight)
and the property test results of Comparative Examples C5 to C8

| Component | | C5 | C6 | C7 | C8 |
|---|---|---|---|---|---|
| Prepolymer | P1 | — | — | 10 | 90 |
| | P2 | — | — | — | — |
| | P3 | — | — | — | — |
| | P4 | — | — | — | — |
| | P5 | — | — | — | — |
| | P6 | — | — | — | — |
| | P7 | — | — | — | — |
| | P8 | — | — | — | — |
| Vinyl | Methacrylate- | — | — | — | — |
| group- | containing | | | | |
| containing | polyphenylene | | | | |
| resin | ether resin | | | | |
| | OPE-2st 2200 | — | — | — | — |
| | SA9000 | 100 | 100 | 100 | 100 |
| | BMI-3000 | — | — | — | — |
| | CHR-2ST | — | — | — | — |
| | Compound of | — | — | — | — |
| | Formula (3) | | | | |
| | 4-vinylbenzocyclo- | — | — | — | — |
| | butene | | | | |
| | Ricon 100 | — | — | — | — |
| | B-1000 | — | — | — | — |
| | Ricon184MA6 | — | — | — | — |
| Additive | H1051 | — | — | — | — |
| | Compound of | — | 29 | — | — |
| | Formula (1.1) | | | | |
| | Compound of | 35 | 6 | — | — |
| | Formula (2) | | | | |
| Filler | SC2050 | 80 | 80 | 80 | 80 |
| Initiator | 2,2′-azobis(2,4,4- | 0.35 | 0.35 | 0.35 | 0.35 |
| | trimethylpentane) | | | | |
| Solvent | MEK | 50 | 50 | 50 | 50 |

| Property | Unit | C5 | C6 | C7 | C8 |
|---|---|---|---|---|---|
| Df@10 GHz | — | 0.0031 | 0.0035 | 0.0030 | 0.0045 |
| P/S | lb/in | 3.74 | 3.65 | 3.42 | 3.04 |
| UL-94 | — | Burn out | V-0 | Burn out | V-0 |
| X-CTE | ppm/° C. | 15.2 | 14.9 | 16.7 | 15.5 |

The following observations can be made from Table 1 to Table 4.

The samples of Examples E1 to E8 which use the resin compositions of the present disclosure can all achieve the following properties: a dissipation factor of less than 0.0030, a copper foil peeling strength of greater than 4.20 lb/in, a flame retardancy of V-0 and an X-axis coefficient of thermal expansion of less than 14.0 ppm/° C.

The prepolymer of Comparative Example C1 is made using only the compound represented by Formula (1) but not using the compound represented by Formula (2) of the present disclosure; the prepolymer of Comparative Example C2 is made using only the compound represented by Formula (2) but not using the compound represented by Formula (1) of the present disclosure; the prepolymer of Comparative Example C3 is made using the compound represented by Formula (1) but not using the compound represented by Formula (2) of the present disclosure; and the samples of Comparative Examples C1 to C3 cannot achieve the following properties: a dissipation factor of less than 0.0030, a copper foil peeling strength of greater than 4.20 lb/in, a flame retardancy of V-0 and an X-axis coefficient of thermal expansion of less than 14.0 ppm/° C.

Comparative Example C4 does not use the prepolymer of the present disclosure while using the compound represented by Formula (1), which is used as a synthesis material of the prepolymer of the present disclosure; Comparative Example C5 does not use the prepolymer of the present disclosure while using the compound represented by Formula (2), which is used as a synthesis material of the prepolymer of the present disclosure; Comparative Example C6 uses the compound represented by Formula (1) and the compound represented by Formula (2) without prepolymerization (i.e. the synthesis materials of the present disclosure but without prepolymerization); and the samples of Comparative Examples C4 to C6 cannot achieve the following properties: a dissipation factor of less than 0.0030, a copper foil peeling strength of greater than 4.20 lb/in, a flame retardancy of V-0 and an X-axis coefficient of thermal expansion of less than 14.0 ppm/° C.

Comparative Example C7 uses 10 parts by weight of the prepolymer; Comparative Example C8 uses 90 parts by weight of the prepolymer; and the samples of Comparative Examples C7 to C8 in which the amount of the prepolymer is beyond the range of 35 parts by weight to 50 parts by weight cannot achieve the following properties: a dissipation factor of less than 0.0030, a copper foil peeling strength of greater than 4.20 lb/in, a flame retardancy of V-0 and an X-axis coefficient of thermal expansion of less than 14.0 ppm/° C.

Based on the above Examples of the present disclosure, the article made from the resin composition of the present disclosure, such as a prepreg, a resin film, a laminate or a printed circuit board, has an excellent performance in at least one of the dissipation factor, the copper foil peeling strength, the flame retardancy and the X-axis coefficient of thermal expansion, therefore, the article can be served as a high-performance substrate that satisfies the comprehensive demands.

What is claimed is:

1. A resin composition, comprising a vinyl group-containing resin and a prepolymer,
wherein the prepolymer is made from a mixture by a prepolymerization reaction, and the mixture comprises a compound represented by Formula (1) and a compound represented by Formula (2) with a molar ratio between 4:1 and 50:1, 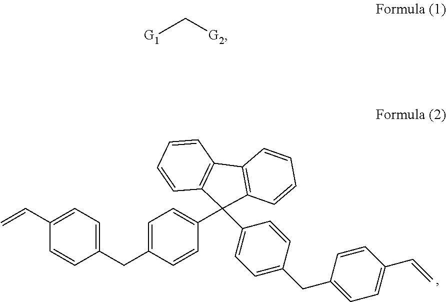
wherein G₁ is 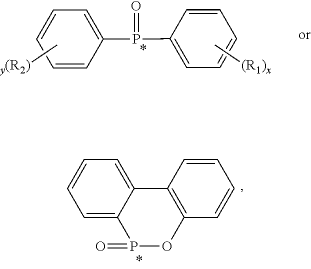
and
G₂ is 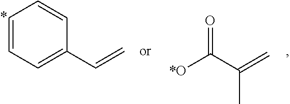
and
wherein a symbol “*” represents a binding site, each of x and y is independently an integer of 0 to 3, and each of R₁ and R₂ is independently C1-C3 alkyl group.

2. The resin composition of claim 1, wherein the mixture is made by the prepolymerization reaction at a temperature of 70° C. to 150° C. for 1 hour to 20 hours.

3. The resin composition of claim 1, wherein a conversion rate of the compound represented by Formula (1) and the compound represented by Formula (2) is between 10% and 90%.

4. The resin composition of claim 1, wherein the resin composition comprises 100 parts by weight of the vinyl group-containing resin and 35 to 50 parts by weight of the prepolymer.

5. The resin composition of claim 1, wherein the vinyl group-containing resin comprises a vinyl group-containing polyphenylene ether resin, a maleimide resin, a diene-containing fluorene compound, a compound represented by Formula (3), a vinylbenzocyclobutene, a styrene-butadiene copolymer, a polybutadiene or a polybutadiene-styrene copolymer grafted with maleic anhydride, 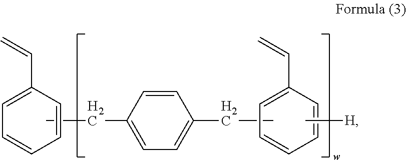
and
w is an integer of 1 to 20.

6. The resin composition of claim 1, further comprising an inorganic filler, a flame retardant, a curing accelerator, a polymerization inhibitor, a solvent, a silane coupling agent, a coloring agent or toughening agent.

7. An article made from the resin composition of claim 1, comprising a prepreg, a resin film, a laminate or a printed circuit board.

8. The article of claim 7, having at least one of the following properties:
a dissipation factor at 10 Hz as measured by reference to JIS C2565 of less than 0.0030;
a copper foil peeling strength as measured by reference to IPC-TM-650 2.4.8 of greater than 4.20 lb/in;
a flame retardancy as measured by reference to UL94 rating of V-0; and
an X-axis coefficient of thermal expansion as measured by reference to IPC-TM-650 2.4.24.5 of less than 14.0 ppm/° C.
